(19) United States
(12) Patent Application Publication
(10) Pub. No.: US 2010/0169779 A1
(43) Pub. Date: Jul. 1, 2010

(54) MULTI-MEDIA PRODUCTION SYSTEM AND METHOD

(76) Inventors: David Clarence Mason, Nashville, TN (US); Adam Gregory Solesby, Franklin, TN (US)

Correspondence Address: CHRISTINE JOHNSON ESQ., 151 Trenton Rd., Fairless Hills, PA, 19030, US

(21) Appl. No.: 12/526,826

(22) PCT Filed: Feb. 13, 2008
(86) PCT No.: PCT/US08/53893

§ 371 Date: Dec. 16, 2009

Related U.S. Application Data
(60) Provisional application No. 60/901,480, filed on Feb. 13, 2007.

(51) Int. Cl. G06F 3/00

(52) U.S. Cl. 715/717; 710/12

(57) ABSTRACT

The invention provides a media editing system comprising a first input/output port for receiving media projects comprising media to be edited and project instructions from a plurality of sources of media projects. The system further comprises a selector for selecting one of said plurality of media editing subsystems for editing a corresponding selected one of said received media projects. The selection based, at least in part, upon received project instructions. A second input/output port provides received media to be edited to the selected one of a plurality of editing subsystems.

### CROSS REFERENCE TO RELATED APPLICATIONS

This application claims benefit of priority to earlier filed U.S. provisional application serial number 60/901,480 to Mason, et al., filed in the USPTO on Feb. 13, 2007 incorporated herein by reference in its entirety.

### FIELD OF THE INVENTION

The present invention relates generally to methods and systems for media editing.

### BACKGROUND OF THE INVENTION

With the evolution and proliferation of digital cameras, personal media recording devices, mobile phones, media players and other media capture and storage devices, millions of people around the world are capturing their memories, events, and daily activities. Modern technology enables any person with access to such a device to create their own media content and to store the content for later access. The growing popularity of consumer capture of multimedia content in the form of media clips, graphics, photos and other content is sky-rocketing. Despite this phenomenon a vast amount of media content captured by consumers using personal and even professional capture technology lies dormant on a storage device. It is forgotten or ignored and is never accessed again.

One explanation for this situation is the lack of time and expertise of many well intentioned home and amateur photographers, filmmakers, musicians to deploy their content in a presentation that is visually appealing and in a format easily shared with family and friends. Broadband connections are increasing the convenience and speed of sharing multimedia presentations via the Internet. At the same time the range of media formats and diversity of devices for displaying media are increasing. A consumer lacking technical knowledge, skills or time to prepare presentations in a suitable format for distribution and sharing cannot take efficiently advantage of these advances in Internet connection technology.

Professional media editing is one option for transforming media content into multi-media presentations. However, conventional editing systems and methods are expensive, time consuming and not well understood by the average consumer. There exists a need for methods and systems enabling consumers and others to rapidly transform their stored media content into aesthetically pleasing presentations in formats suitable for sharing. There exists a need for methods and systems that are consumer friendly, easily accessible, convenient to use and at the same time capable of providing a finished product within a consumer's budget and cost constraints.

At the same time there is a need for methods and systems that allow media editors to offer their professional services to a wider consumer base than is presently possible. The media content provided by existing systems is typically of short duration. The quality of the resulting product often falls short of expectations and desires of viewers and content creators alike. Further, the media products provided by existing systems and methods are not intended or suitable for extended viewing. Third, mechanisms for sharing, evaluating, appraising and marketing user created media and other multimedia products are not sufficiently developed to allow a typical user to undertake multimedia projects without relying heavily on a number of diverse professional resources. These professional resources are difficult for the average user to identify and locate. Access to such resources is typically beyond the reach and affordability of the average layperson seeking to create media and multimedia products with a professional look and feel.

The present inventors have recognized an increasing demand from a diverse population of creators of multimedia content, e.g., artists, musicians, home media enthusiasts, amateur and even professional cinematographers, educators and a host of other creative people. The demand is for simple, effective, interactive and efficient systems and methods for managing their multimedia projects.

### SUMMARY OF THE INVENTION

Various embodiments of the invention provide simple, effective, interactive and efficient systems and methods for editing media to generate multimedia products.

### DESCRIPTION OF THE DRAWING FIGURES

These and other objects, features and advantages of the invention will be apparent from a consideration of the following detailed description of the invention considered in conjunction with the drawing Figures, in which:

FIG. 1 is a functional block diagram of a multimedia editing system according to an embodiment of the invention;

FIG. 2 is a flowchart illustrating steps of a method for editing multimedia according to an embodiment of the invention;

FIG. 3 is a functional block diagram including further details of the first input/output interface of the system illustrated in FIG. 1

FIG. 4 is a functional block diagram illustrating further details of the second input/output interface of the system illustrated in FIG. 1

FIG. 5 illustrates a graphical user interface provided by an embodiment of the invention.

FIG. 6 illustrates a graphical user interface provided by an embodiment of the invention.

FIG. 7 illustrates a graphical user interface provided by an embodiment of the invention.

FIG. 8 illustrates a graphical user interface provided by an embodiment of the invention.

### DETAILED DESCRIPTION OF THE INVENTION

The system and methods of the invention provide scheduling and coordination functions for use in the production of multimedia presentations. Various production media resources such as video, dialog audio, special effects, music audio, and graphics are be edited and selectively integrated into the overall production.

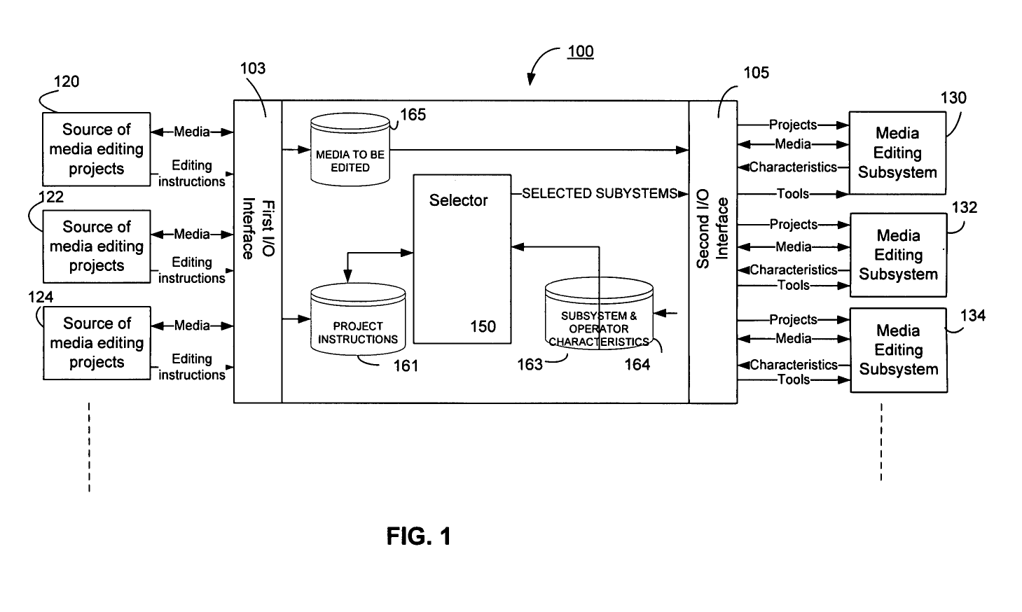

### FIG. 1 System Functional Block Diagram

FIG. 1 is a functional block diagram of a multimedia editing system 100 according to an embodiment of the invention. Media editing system 100 comprises a first input/output interface 103 configured to receive media projects from at least one of a plurality of sources of media projects, e.g., 120, 122, 124. A media project comprises media to be edited as well as project instructions related to the media to be edited. For purposes of illustration three sources of media projects 120, 122 and 124 are illustrated in FIG. 1. However, it will be readily understood upon reading this specification that system 100 is not limited with respect to the number of sources of media projects from which system 100 receives projects via first input/output interface 103. For example in embodiments of the invention wherein first I/O interface is configured for communication with sources of media projects via the Internet, the number of sources of media projects is virtually unlimited.

System 100 further comprises a second I/O interface 105 for communicating with at least one of a plurality of multi-media editing subsystems (or “subsystems” 130, 132 and 134. For purposes of illustration three multi-media editing subsystems 130, 132 and 134 are illustrated in FIG. 1. However, it will be readily understood upon reading this specification that system 100 is not limited with respect to the number of multi-media editing subsystems 130, 132,134 with which system 100 can communicate via second input/output interface 105. For example in embodiments of the invention wherein second I/O interface is configured for communication with multi-media editing subsystems 130, 132 and 134 via the Internet, the number of multi-media editing subsystems 130, 132 and 134 is virtually unlimited.

System 100 further comprises a selector 150 for selecting at least one of the plurality of media editing subsystems 130, 132 and 134 to edit a received media project. System 100 further comprises subsystem characteristics and subsystem operator characteristics 163 and 164. In one embodiment of the invention the selection of subsystem for a project is based, at least in part upon project instructions received from the source of media projects providing the project, and at least in part on characteristics of the subsystems 130, 132 and 134 and subsystem operators. When the selected media editing subsystem completes a project, system 100 receives the competed project via I/O interface 105. System 100 subsequently provides the completed media project to the source of the project.

### Source of Media Editing Projects

Sources 120, 122, 124 of media editing projects suitable for use in association with system 100 include, but are not limited consumer systems and devices storing outputs of consumer multimedia capture devices, such as motion video cameras, film, and audio capture devices. Sources of media editing projects further comprise devices storing consumer generated media including text, graphics, video, audio and the like. Further sources of media editing projects include real time outputs of such devices. A wide variety of technology for media viewing and purchasing is suitable generating media to comprise a source of a media editing project.

For example, one embodiment of the invention contemplates a source of media editing project comprising a camera phone communicating with a server. Various embodiments of the invention include sources of media editing projects relying on technology adapted for compatibility with non American markets, for example Western European and Asian markets. Examples of devices suitable to comprise a source of a media editing project include cell phones, for example, the Motorola RAZR, the Motorola e815, the Nokia 6102 and the Palm One Treo 650, all of which have built-in high-resolution cameras and digital video recorders.

Sources of media projects further comprise sources of projects undertaken in preparation for presentation in a media presentation forum, for example, YouTube™ or MySpace™. Sources of media editing projects include hardware and software systems, devices and components configured to for any of the following tasks: generate or store media, upload media, provide project instructions, preview edited media, share edited media, exhibit edited media and interact with others to obtain feedback relating to the edited media.

### Media

The term “media” as used herein refers to any type of media, data, or file comprising content for presentation in any form or forum. Examples of media include, but are not limited to photographs, video clips, audio clips, sound or other visual or audio element, graphic art, text documents, text and graphic overlays, templates and the like.

Media for media editing projects can comprise media obtained from third party sources such as and Apple (iTunes™), iTV™ service, Amazon's Unbox™ movie download service. In one embodiment of the invention, media files comprising media for projects are identified by a URL (universal resource locator or web address). In that case system 100 downloads and processes these files in the same manner as other media. This function allows users to include media stored on a third party provided web service.

### Project Instructions

Project instructions comprise instructions related to the desired look and feel of a multimedia product generated by system 100. Project instruction also comprise details about the kind of project, for example, “on site shoot” that indicate what type of subsystem equipment is appropriate for a project. The instructions are provided by a source of media editing projects in association with providing media to be edited to system 100. Project instructions also comprises instructions related to format of the edited media, aesthetic preferences, genre preferences, music and audio preferences, cost constraints, length of the edited media presentation and any other personal or commercial information relevant to the editing functions to be carried out on media provided by a source of media editing projects.

### Graphical User Interface (GUI)

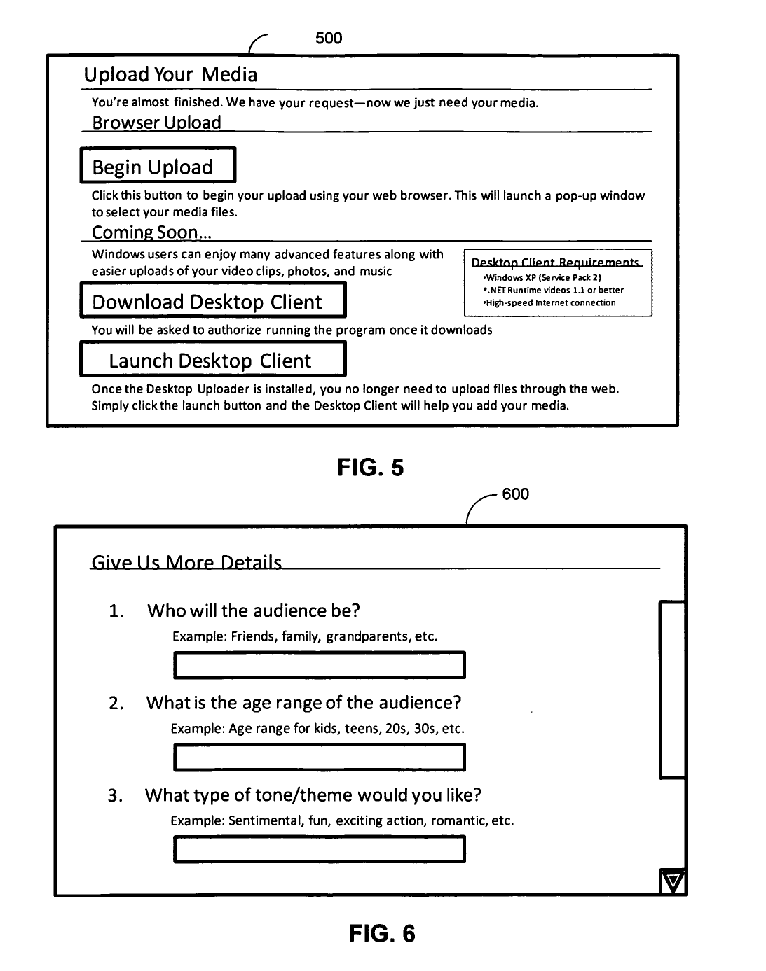

According to one embodiment of the invention, system 100 provides a website accessible by personal computers, personal digital assistants, mobile phones, and other devices. FIGS. 5 and 6 illustrate examples of graphical user interfaces (GUI) 500 & 600 for deployment in conjunction with some embodiments of the invention. GUI 500 comprises an interactive menu for enabling a source of a media editing project to provide instructions to system 100 for carrying out the project. In one embodiment GUI 500 includes interactive tools that enable users to drag and drop media, for example photos and other media content from a system comprising a source of a media editing project to the website of system 100.

### Media Editing Subsystem

System 100 is configured to communicate with a plurality of sources of media projects 120, 122 and 124 and a plurality of media editing subsystems 130, 132, 134. Media editing subsystems include professional systems, devices and components enabling a professional editor (subsystem operator) to operate on media comprising a media editing project. Examples of media editing subsystems include, but are not limited to editing hardware and software tools, color management hardware and software tools, restoration hardware and software tools, professional cinematography equipment among many others. Media editing subsystems further comprise professional editors (operators) and their associated skills, availability and project preferences. Examples of professionals contemplated by embodiments of the invention to be associated with media editing subsystems include, but are not limited to directors, colorists, graphics artists, special effects specialists, sound specialists, musicians and language translators to name but a few. One or more professionals operate on, or otherwise contribute to the editing of media to provide a product to a customer.

### Media Editing Subsystem Characteristics

Media editing subsystem characteristics define a media editing subsystem in terms of its technical potential to carry out a media editing project in accordance with project instructions and project specifications. System 100 receives information related to media editing subsystem characteristics from the subsystems and subsystem operators themselves. The information is provided by operator interaction with a graphical user interface (GUI) provided by system 100. An operator responds to questions about the operator's subsystem and its technical capabilities. System 100 stores characteristics of media editing subsystems, for example in a memory 163. Media editing subsystem characteristics include editing capabilities, digitizing capabilities, media encoding, digital video conversion, color management, integration/mixing with other projects, mixing together assets with licensed content (music videos, major motion picture footage), ability to allow for customization of stock footage, project management and accounting activities, menu design activities, creation of bonus material, “look and feel” design, image and audio restoration, title and subtitle creation, sound services, language translation, regionalization, quality control and other aspects of media/movie production and DVD project management, to name but a few characteristics.

### Subsystem Operator Characteristics

In addition to subsystem characteristics stored in memory 163, operator characteristics are stored in memory 164. Operator characteristics include, but are not limited to characteristics relating to an editor and the editors project preferences, availability and skills. Examples of characteristics relating to an editor and the editors preferences include the following: editor's style preference, editor preference for duration of an editing project; editor skill as indicated for example by an editor rating; editor seniority; number of projects completed by an editor; number of project products purchased by a customer associated with an editor, editor rating by peer review; editor experience level, and the like.

### Media Editing System 100

Media editing system 100 provides an automated system configured to manage a media editing project. Media editing system 100 receives media in a variety of formats, for example, raw footage of scenes from sources of media editing projects. System 100 operates in cooperation with media editing subsystems and operators to transform the received media into a product comprising a multimedia presentation, for example a movie. The product is characterized in that a professional look and feel is achieved. Embodiments of the invention match sources of media editing projects with media editing subsystems operated by directors, editors and/or other professionals qualified to contribute to a project.

### Selector

Media editing system 100 comprises a selector 150. Selector 150 operates to match incoming projects from sources of media editing projects with corresponding media editing subsystems and subsystem operators. The selection of a media editing subsystem to associate with a project from a source of media editing projects is made in accordance with the subsystem and operating characteristics described above.

Examples of matching criteria suitable for matching a project with a media editing subsystem include, but are not limited to: turnaround time and other factors that consider delivery of a product to a source of a media project as quickly as possible; a quality level for a project or for a subsystem or for an editing professional; a customer purchase rate associated with a particular subsystem; editor/professional satisfaction, and availability of a subsystem, to name but a few suitable factors.

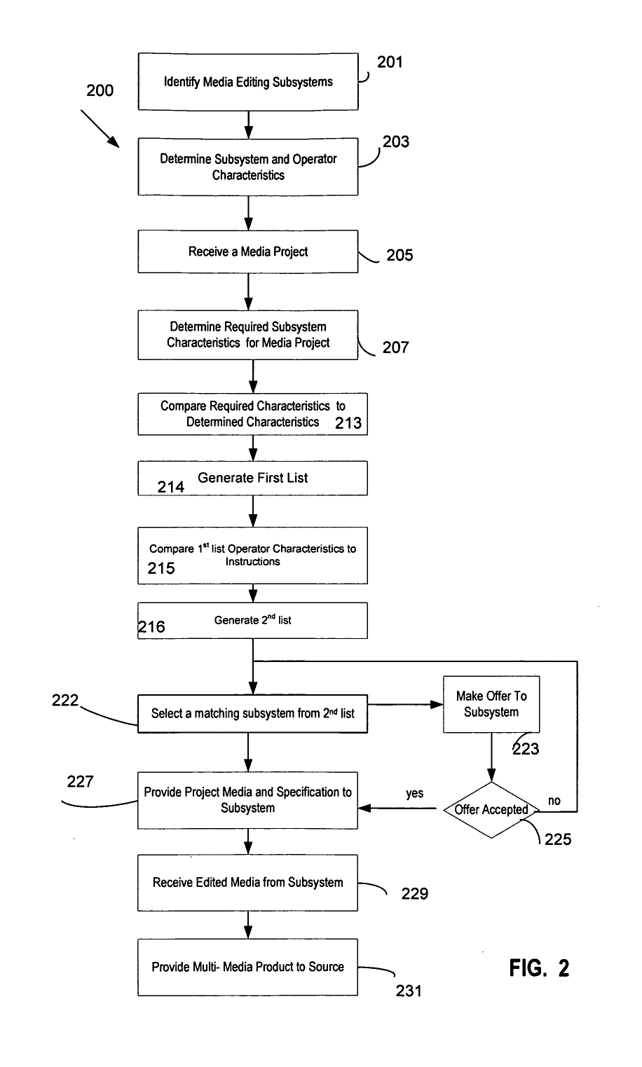

### FIG. 2 Flow Chart of Method Steps

FIG. 2 is a flowchart illustrating steps of a method for editing multimedia according to an embodiment of the invention.

### Identify Media Editing Subsystems

At step 201 media editing subsystems are identified. In some embodiments of the invention identification of media editing subsystems is accomplished by providing a graphical user interface enabling editing subsystem candidates to identify themselves to system 100. According to one embodiment of the invention, upon receiving an indication that an editing subsystem has identified itself to system 100, system 100 automatically initiates an editor qualification process. According to one embodiment of the invention, an editor qualification process carried out by system 100 includes a step of automatically providing a media editing exercise to be completed by an editor associated with the identified media editing subsystem. According to one embodiment of the invention system 100 receives the completed exercise from a subsystem and automatically evaluates the completed exercise. In one embodiment of the invention the media editing subsystem is selected based, at least in part, on the results of the evaluation.

According to one embodiment of the invention a plurality of professionals associated with media editing subsystems are automatically solicited, screened and selected to comprise a media editing subsystem candidate list. In one embodiment of the invention media editing subsystems are identified off line and information relating to the subsystems is provided to system 100.

### Determine Subsystem And Operator Characteristics

At step 203 media editing subsystem characteristics are determined. Examples of media editing subsystem characteristics are described above with respect to FIG. 1. Other media editing subsystem characteristics determined in step 203 can include preferred container file format, audio or video codec, bitrate, file size, compression, additional project-based metadata, and removal of extraneous data.

### Receive A Media Project From A Source

At step 205, system 100 receives a media project from a source of media to be edited. A media project includes media to be edited and instructions for carrying out the project. In one embodiment of the invention the receiving step includes steps of automatically analyzing received media for container format, audio and video codec, duration, and associated metadata including by not limited to timestamp, geographic location coordinates, capture device, author, etc.

FIG. 500 illustrates a GUI for enabling system 100 to receive media from a source of media.

### Determine Subsystem Characteristics

At step 207 a determination is automatically made about the capabilities needed by a subsystem to carry out the received project. In one embodiment of the invention step 207 is carried out by analyzing instructions received at step 205, for example by executing a computer program to carry out the analysis.

### Match Product Specifications To Subsystem Characteristics

At step 213 the capabilities needed for a project as determined in step 207 are automatically compared to stored subsystem characteristics determined in step 203. In that manner media editing subsystems having the capability to meet the product specifications are automatically identified.

### Provide List of Matching Media Subsystems

At step 214 a first subsystem candidate list is automatically generated. The first list comprises a subset of all available subsystems identified in step 201. The first list comprises subsystems identified as having capabilities and characteristics needed to carry out a project.

### Match Operator Characteristics To Instructions

At step 215 stored operator characteristics for operators associated with subsystems on the list provided at step 214 are compared to instructions received in step 205 to automatically select a subsystem having an associated operator meeting the criteria for a project as provided in the project instructions. According to one embodiment of the invention a selecting step includes steps of selecting professionals based on a comparison of stored operator characteristics, e.g., availability, expertise and editor rating, with characteristics identified in project instructions. For example, operators not available or not eligible for a project are not considered for project matching. Stored operator characteristics are obtained by providing operators with a GUI enabling operators to specify project preferences, for example, time and day of week availability. Using the system GUI operators can specify temporary vacation periods during which they will not receive projects. Location and time zone of editor versus the date of project submission and location of the customer are further examples of the comparison made in step 215.

Based on the results of the comparison carried out in step 215 a second list comprising subsystem candidates for a project is automatically generated at step 216.

At step 222 at least one candidate is selected from the second list. In one embodiment of the invention a minimum of 3 and a maximum of 10 subsystem candidates are selected from the second list. In one embodiment of the invention candidates are selected from the second list based on best-fit qualitative attributes determined in the previous steps.

In one embodiment of the invention step 222 is carried out by steps of offering a project to a media editing subsystem (at 223) comprising a candidate on the second list and determining if the offer is accepted at 225. If the offer is accepted step 227 is carried out. If the offer is not accepted the process repeats step 222 to select a next media editing subsystem from the candidates selected from the second list.

### Provide Project Media And Project Specification To Subsystem

At step 227 project media, instructions and specifications are provided to at least one of the media editing subsystems selected in step 222. In one embodiment of the invention the media is provided to a subsystem so as to enable the subsystem operator, e.g., an editor, director, or other specialist to work at least a portion of the project. In one embodiment of the invention processed media (along with original received media) are made available for fast downloading to a subsystem utilizing various protocols including HTTP, BitTorrent, and other peer-to-peer protocols. The assets are prepared for downloading as a single download package comprising all the files. Depending on the project type, other assets may be created including style guidelines, project template files, fonts, generated graphics that contain computer rendered text provided by the customer.

### Receive Finished Project From Subsystem

Upon completion of a project, at step 229, edited media is received from a media editing subsystem.

### Provide Finished Project To Source

At step 231 the edited media comprising a completed project is provided to the source of the project.

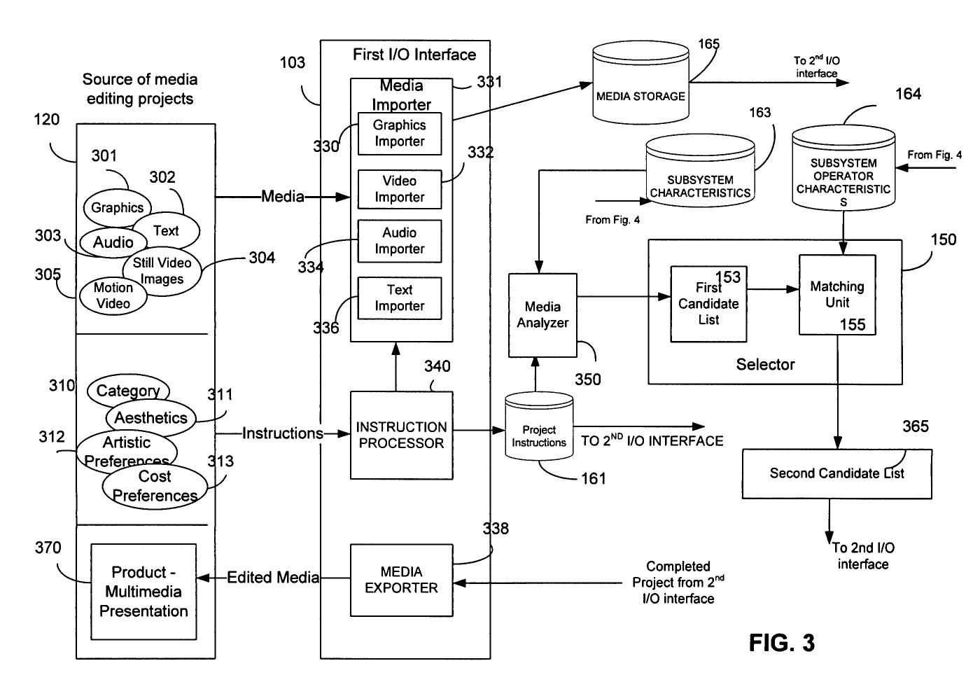

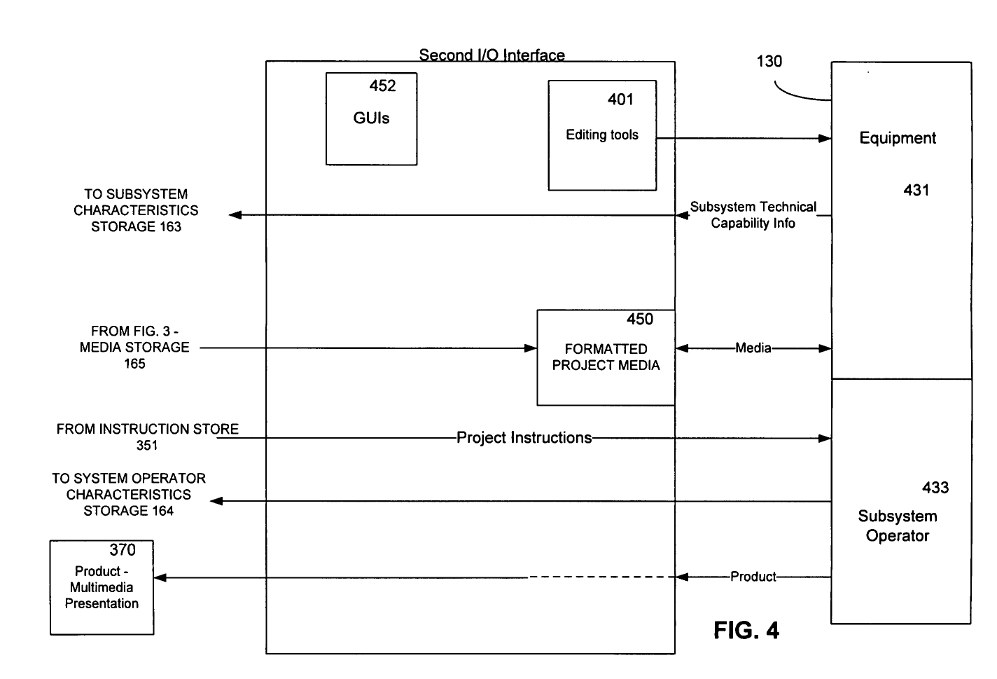

### FIG. 3 Functional Block Diagram—First I/O Interface

FIG. 3 is a block diagram of the system 100 illustrated in FIG. 1 including further details of first I/O interface 103. According to embodiments of the invention first I/O interface 103 comprises a media importer. Media importer uploads media files, for example graphics files 301, text files 302, audio files 303, still image files 304 and motion video files 305 from a source of media projects 120. Media importer 331 comprises media translators, for example, graphics importer 330, video importer 332, audio importer 334 and text importer 336.

First I/O interface includes an instruction processor 340 that analyzes received instructions and provides instructions for media translation to media importer 331. Media importer 331 performs video and audio encoding conversion on files it uploads from source 120 in accordance with instructions provided by a source of media editing projects 120. In one embodiment of the invention media importer 331 processes audio, image, and video files by transcoding at least a portion of the files to a common format, or to a format specified in instruction received from instruction processor 340. Media importer 331 optimizes quality and file size, and is consistently available on a media editing subsystem.

System 100 is capable of processing media comprising a plurality of video and audio encoding types (coder/decoders (codecs)). System 100 is capable of processing a plurality of file types and file formats that contain video and audio encodings. System 100 is capable of processing a plurality of video and audio tracks contained in a single enclosure. System 100 is capable of processing media files including video files comprising a wide range of file sizes.

In one embodiment of the invention first I/O interface is configured to communicate with sources of media editing projects via the Internet. Other embodiments of first I/O interface are configured to communicate with sources of media editing projects via local area networks, wide area networks, regional area networks and other networks.

System 100 further comprises a media analyzer 350. Media analyzer 350 automatically analyzes project instructions stored in project instruction store 161 to determine characteristics of the media comprising a project. The results of the analysis are compared to subsystem characteristics stored in subsystem characteristic storage 163. Media analyzer 350 selects subsystems associated with subsystems characteristics matching the requirements of a project as determined by the project instructions. Media analyzer 350 outputs a first candidate list 153 comprising subsystems with matching subsystem characteristics.

Selector 150 comprises first candidate list 153 and a matching unit 155. Matching unit 155 compares the characteristics of subsystem operators associated with candidate list 153 with instructions provide by project instruction store 161. The analysis considers, for example, requirements of project, and preferences of projected professional who will work on project. Based on the analysis a second list 365 is generated.

Media storage 165 comprises media for projects. The processed media(along with original raw assets) are made available for fast downloading to selected subsystems utilizing various protocols including HTTP, BitTorrent, and other peer-to-peer protocols. The assets are prepared for downloading as a single download package comprising all the files. Depending on the project type, other assets may be created including style guidelines, project template files, fonts, generated graphics that contain computer-rendered text provided by the customer.

According to one embodiment of the invention system media analyzer 103 is configured to inspect media clips for relevant meta-data. For example, in one embodiment analyzer 350 converts word processing file formats to text and attaches the text to the project instructions received from the corresponding source of the media. Thus the text is viewable by a media editing subsystem matched to the project.

According to some embodiments of the invention media analyzer 350 is further configured to perform meta-data extraction and cataloging. Metadata contains, for example, dates and times of recording, markers and duration of sub-segments, quality levels, encoding formats, type of recording equipment, song track title, artist name, album, and year of recording, user preferences and ratings of audio and video. Using media analyzer 350 system 100 extracts these items and catalogs them.

### FIG. 4 Functional Block Diagram—Second I/O Interface

FIG. 4 is a functional block diagram illustrating further details of the second input/output interface of the system illustrated in FIG. 1. Second I/O interface 105 communicates with media editing subsystems to enable the subsystems to receive projects, assets, instructions and specifications for carrying out media editing functions to complete a media project. In addition second I/O interface enables the subsystems to access editing tools 401 comprising production media resources such as video, dialog audio, special effects, music audio, and graphics provided by components of system 100. Using these components, the editing subsystems are enabled to carry out media editing functions and to selectively integrate commonly available and accessible media resources into the overall media production for a project.

In one embodiment of the invention, media including audio, image, and video files are optimized for quality and, file size, and is consistently available on a media editing subsystem via second I/O interface. Embodiments of I/O interface 105 provide tools for executing automated processing functions including those selected from the group including, but not limited to the following: Video downsizing, for example to enable offline/online video editing. As a result a professional, for example, an editor is enabled to work with smaller, lower quality video files than would otherwise be possible. The professional/editor can then upload EDL (edit decision lists) and project files to a central server to render using the full quality assets.

In one embodiment tools provided by I/O interface 105 maximize the efficiency of professionals, e.g., editors by performing tasks that are tedious and/or repetitive. Embodiments of I/O interface 105 include automated functions for detecting and correcting unanticipated and/or undesirable events and results that sometimes occur in the process of media production.

Image rotation and translation—In some embodiments of the invention tools provided by second I/O interface 105 include components that perform image rotation and/or image translation. In one embodiment image rotation is performed using meta-data within the image. In one embodiment of the invention tool include converters for converting raw images and other formats to a format selected from the group including, but not limited to a JPEG format. Further examples of tools include image downsizing tools. In one embodiment of the invention tools for downsizing still images to a common dimension (for example if still images are larger than optimal are provided. This is useful since many images taken directly from a camera are larger than desirable for performing editing functions). In one embodiment of the invention tools include tools for selecting a setting for maximizing quality of video inclusion and printing without needing to store full-resolution images.

Embodiments of the invention include utilities for removing unnecessary files from editor and user downloaded and uploaded information. For example, in some cases user downloaded files can include system files that the user did not intend to transfer. System 100 removes these. For example in one embodiment of the invention System 100 discards operating system thumbnail databases from a downloaded file. In one embodiment of the invention these files are also prevented from upload when used in conjunction with desktop upload software.

### Product Sharing Module

According to embodiments of the invention system 100 further includes components and modules providing web-based systems and methods for creating virtual communities in which laypersons and professionals can collaborate on multimedia editing projects. Embodiments of the invention provide methods and systems for connecting consumers with a virtual community of expert editors. In so doing, the invention brings the Internet video revolution to the public. The invention enables laypersons and experts alike to participate, communicate create and share their content with others. For example family members can share high quality personalized multimedia experiences to other family members and those who matter most in their lives.

According to one embodiment of the invention purchased products, including movies are downloaded and mailed to the user on a DVD, hosted on a website, sent to friends specified by the user or, in some embodiments of the invention, sold to other users. The user can elect to make the product/movie private or public. In one embodiment of the invention the private option is selected by the system as a default.

In one embodiment system 100 enables a user to share a product with at least one of the groups comprising at least one friend and the public. According to some embodiments of the invention system 100 provides users with options for determining how the product will be shared and/or distributed and sold. Some embodiments of system 100 comprise modules for managing publication rights and permissions related to the product in accordance with instructions from a user.

While the invention has been shown and described with respect to particular embodiments, it is not thus limited. Numerous modifications, changes and enhancements will now be apparent to the reader. While the invention has been shown and described with respect to particular embodiments, it is not thus limited. Numerous modifications, changes and enhancements will now be apparent to the reader.

We claim:

1. A media editing system comprising:
a first input/output port for receiving media projects comprising media to be edited and project instructions from a plurality of sources of media projects;
a selector for selecting one of said plurality of media editing subsystems for editing a corresponding selected one of said received media projects, the selection based, at least in part, upon said received project instructions;
a second input/output port for providing said received media to be edited to the selected one of a plurality of editing subsystems, and for receiving edited media from said selected one of said media editing subsystems.

2. The system of claim 1 wherein said media editing system further comprises a stored list of characteristics of said media editing subsystems, and wherein said selector includes an analyzer configured to analyze said received project instructions and said list and to select said one of said plurality of media editing subsystems based at least in part upon a correspondence between said received project instructions and said stored characteristics.

3. The system of claim 1 wherein said first and second input/output ports are configured for communication with said sources of media editing projects and with said media editing subsystems via the Internet.
